(19) United States
(12) Patent Application Publication
(10) Pub. No.: US 2012/0246814 A1
(43) Pub. Date: Oct. 4, 2012

(54) SOLAR AUTO-SENSING OUTLET VALVE WITHOUT A USE OF BATTERIES AND ADAPTED CIRCUIT STRUCTURE THEREOF

(76) Inventor: Su HUANG, Nantou City (TW)

(21) Appl. No.: 13/074,338

(22) Filed: Mar. 29, 2011

(51) Int. Cl. E03D 5/10; F16K 31/02

(52) U.S. Cl. 4/313; 251/129.04

(57) ABSTRACT

A solar auto-sensing outlet valve without a use of batteries and adapted circuit structure thereof comprises at least one solar board and an outlet valve body. The solar board is disposed near a light source for converting light into electricity and is electrically connected with the outlet valve body via a guiding line, facilitating to a normal operation of a sensor and an electromagnetic valve inside the outlet valve body. For the outlet valve body, the use of batteries or an electrical connection with any commercial powers is unnecessary for reducing the energy consumption and environmental sufferings.

### BACKGROUND OF THE INVENTION

1. Field of the Invention

The present invention generally relates to a structure of an auto-sensing outlet valve, more particularly to a solar auto-sensing outlet valve and its relevant circuit structure.

2. Description of the Related Art

Along with the gradual development of society and the increasing concern about the environmental protection, numbers of daily auto-flushing apparatus have been recently developed on the market and installed in the bathroom for users to automatically flush the toilet after using and for saving the water. With regard to a common flushing apparatus, it needs to connect with a power source to keep the interior controlling system operating, so the operation of the apparatus always relies on an electrical communication with batteries or other commercial powers. Whereas, the flushing apparatus cannot work when the power is shutdown or the batteries are in low charge, which even causes a smelly environment and increases the difficulty in cleaning. Further, the replacement of batteries and the use of commercial powers are detrimental to the energy saving and environmental protection, thus requiring improvements.

### SUMMARY OF THE INVENTION

Therefore, the object of the present invention is to provide a solar auto-sensing outlet valve without using batteries and its adapted circuit structure.

The solar auto-sensing outlet valve without the use of batteries in accordance with the present invention mainly comprises an outlet valve body and at least one solar board. The outlet valve body further includes a sensor and an electromagnetic valve. The sensor serves to detect whether users are going nearby and send a corresponding message to the electromagnetic valve for triggering the action of the electromagnetic valve, so as to render the outlet valve body able to automatically output and stop outputting water. The solar board is disposed to separate from the outlet valve body and arranged in the vicinity of a light source. Further, the solar board is electrically connected with the sensor and the electromagnetic valve of the outlet valve body via a guiding line, and said solar board is able to combine with a plurality of other solar boards for satisfying demands.

The circuit structure adapted to the solar auto-sensing outlet valve without the use of batteries comprises a solar circuit, a microcomputer unit, a voltage determining unit, an object-sensing circuit, and an electromagnetic valve driving circuit. The solar circuit includes at least one solar board, which is able to combine with a plurality of other solar boards for satisfying demands. The microcomputer unit is electrically connected with the solar circuit and comprises a basic circuit and an electronic element for controlling a normal operation of the auto-sensing outlet valve. The voltage determining unit is arranged between the solar circuit and the microcomputer unit and is respectively in an electrical connection with the solar circuit and the microcomputer unit. The object-sensing circuit is electrically connected with the microcomputer unit to detect an approach of an object, accordingly create a message responding thereto, and send the message to the microcomputer unit. The electromagnetic valve driving circuit is also electrically connected with the microcomputer unit to receive an instruction command from the microcomputer unit so as to control the electromagnetic valve to execute an on-off action. From above, the voltage determining unit is able to detect whether a voltage of the solar board is full enough to drive the object-sensing circuit and the electromagnetic valve driving circuit for the auto-sensing outlet valve to maintain a normal operation.

By electrically connecting the solar board in the vicinity of the light source with the auto-sensing outlet valve via the guiding line, the electricity created by the solar board facilitates a normal operation of the auto-sensing outlet valve, so that the use of auto-sensing outlet valve attains effects of energy saving and environmental protection.

The advantages of the present invention over the known prior arts would become more apparent to those of ordinary skilled in the art by reading the following descriptions with the relating drawing.

### BRIEF DESCRIPTION OF THE DRAWINGS

FIG. 1 is a diagram chart showing a preferred embodiment of the present invention;

FIG. 2 is a schematic view showing the preferred embodiment of the present invention;

FIG. 3 is a circuit diagram showing the preferred embodiment of the present invention; and

FIG. 4 is a flow chart showing the preferred embodiment of the present invention.

### DETAILED DESCRIPTION OF THE PREFERRED EMBODIMENTS

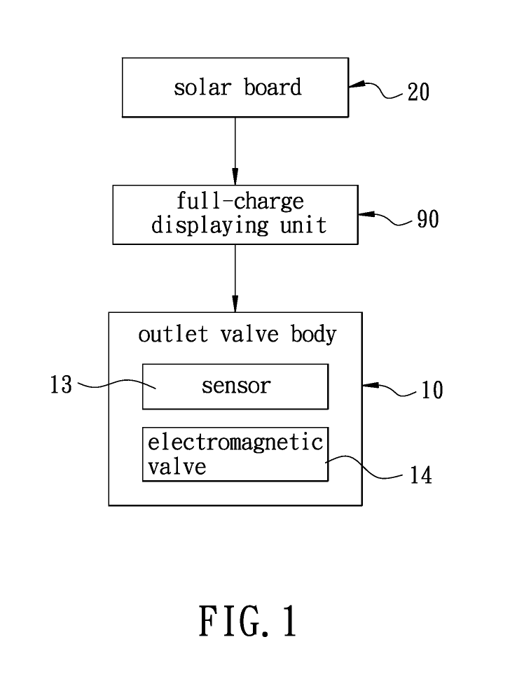

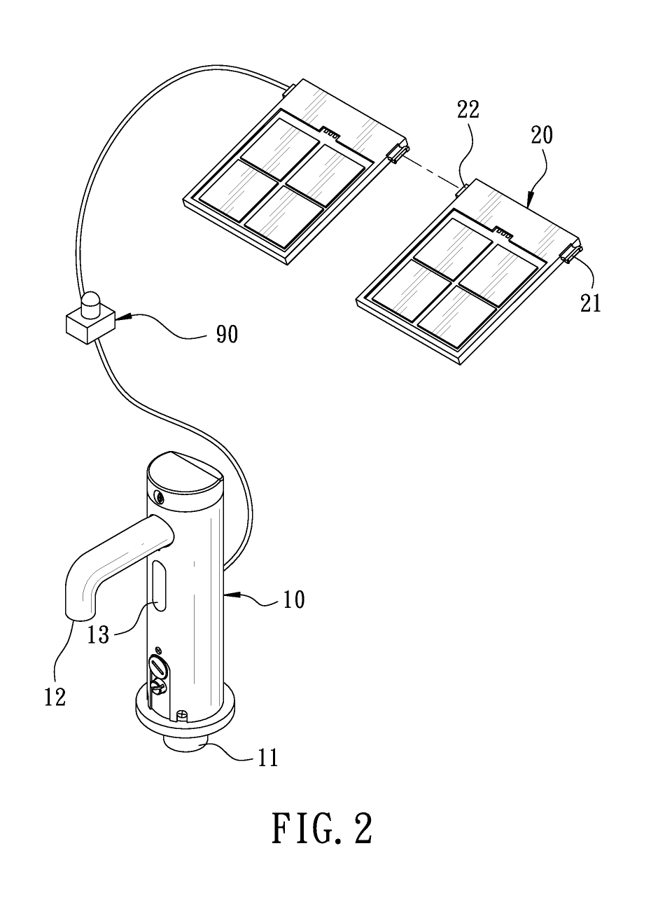

Refer to FIGS. 1 and 2 showing a solar auto-sensing outlet valve in accordance with the present invention. The outlet valve applied to a faucet product is described hereto. The solar auto-sensing outlet valve mainly comprises:

An outlet valve body 10 has a water inlet 11 and a water outlet 12 disposed at two ends thereof. An interior of the outlet valve body 10 includes a sensor 13 and an electromagnetic valve 14 disposed therein. The sensor 13 serves to detect if users are going nearby and accordingly send a corresponding message to the electromagnetic valve 14 for triggering the electromagnetic valve 14 to work, so that the outlet valve body 10 is able to automatically outlet and stop outputting water.

At least one solar board 20 is separately disposed from the outlet valve body 10 and disposed in the vicinity of a light source for converting light into electricity. The solar board 20 is electrically connected to the sensor 13 and the electromagnetic valve 14 of the outlet valve body 10 via a guiding line, and an electric plug 21 and an electric socket 22 are respectively and relatively disposed at two sides of the solar board 20, whereby the user can connect two adjacent solar boards 20 together by relatively plugging the electric plug 21 in the adjacent electric socket 22 for satisfying user's demands. Herein, the solar boards 20 are in parallel connection as illustrated.

A full-charge displaying unit 90, as an LED light, is disposed between the solar board 20 and the outlet valve body 10 and respectively in an electrical connection therewith. The displaying unit 90 is applied to recognize whether a voltage of the solar board 20 is full enough to drive the sensor 13 and the electromagnetic valve 14 of the outlet valve body 10, so as to maintain a normal operation of the auto-sensing outlet valve.

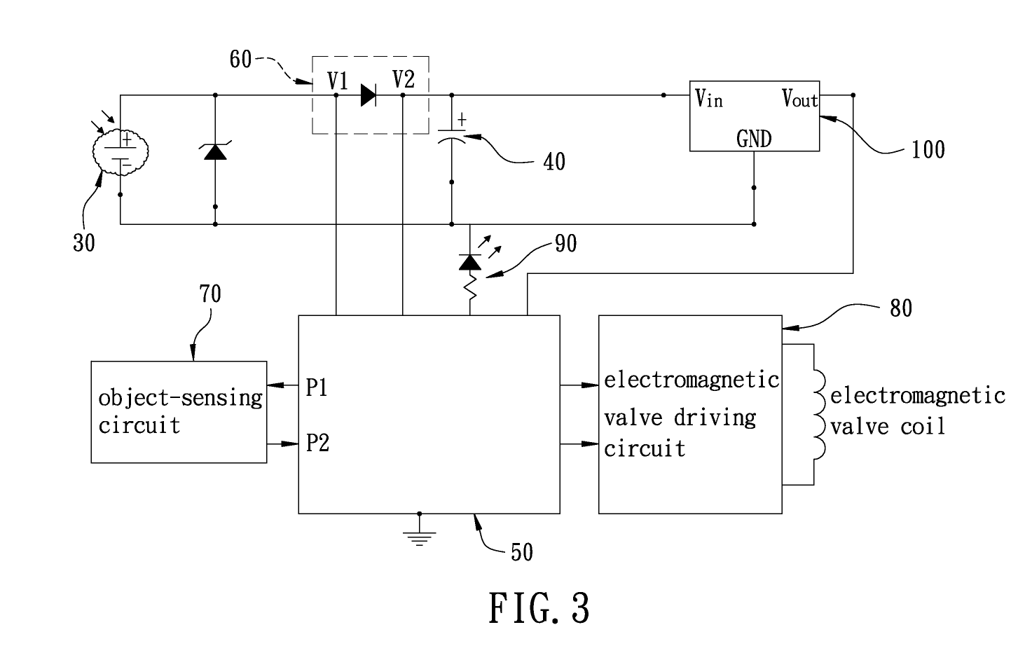

Refer to FIG. 3 showing a circuit diagram adapted to the present solar auto-sensing outlet valve, which comprising:

A solar circuit 30 includes at least one solar board 20 capable of converting the light absorbed by the solar board 20 into electricity. The solar board 20 is able to combine with a plurality of other solar boards 20 for satisfying demands.

A capacitor 40 is electrically connected with the solar circuit 30 to store the electricity created by the solar circuit 30 and provide the solar auto-sensing outlet valve with electricity for keeping a normal operation.

A microcomputer unit 50 is electrically connected with the solar circuit 30 for controlling an operation of the whole circuit of the solar auto-sensing outlet valve.

A voltage determining unit 60 is arranged between the solar circuit 30 and the microcomputer unit 50 and respectively in an electrical connection therewith. The voltage determining unit 60 comprises a first node V1 and a second node V2. The first node V1 is applied to detect a voltage value of the solar circuit 30 and decide whether the light source is on or off. The second node V2 is applied to detect the capacitor 40 where the main power is temporarily stored and decide the quantity of electricity of the capacitor 40. When the microcomputer unit 50 receives that the voltage values of the first node V1 and the second node V2 reach a predetermined voltage threshold, respectively, the microcomputer unit 50 thence controls the whole circuit operation of the auto-sensing outlet valve. In the preferred embodiment, the predetermined voltage threshold for the first node V1 is 5.5 VL, and the predetermined voltage threshold for the second node V2 is 7 VH.

An object-sensing circuit 70 is electrically connected with the microcomputer unit 50 to detect and create a message responding to an approach of an object and send the message to the microcomputer unit 50.

An electromagnetic valve driving circuit 80 is electrically connected with the microcomputer unit 50 to receive an instruction command from the microcomputer unit 50 so as to control the electromagnetic valve 14 to execute an on-off action.

A full-charge displaying unit 90 is electrically connected with the microcomputer unit 50, so that the full-charge displaying unit 90 flashes when the microcomputer unit 50 detects that the voltage determining unit 60 reaches the predetermined voltage threshold. In the preferred embodiment, the full-charge displaying unit 90 is an LED light.

A stabilizing circuit 100 is electrically disposed between the microcomputer unit 50 and the voltage determining unit 60, so that the stabilizing circuit 100 is able to keep the voltage converted by the solar circuit 30 firm.

Referring to FIGS. 2 and 3, when the solar board 20 gets ready, the solar circuit 30 begins to convert the light into electricity, increase the voltage thereof, and at the same time charge the capacitor 40. Then, when the microcomputer unit 50 detects that both the first node V1 and the second node V2 of the voltage determining unit 60 reach the predetermined voltage threshold, the full-charge displaying unit 90 flashes once. Whereas, if the voltage of the voltage determining unit 60 still fails to reach the threshold as predetermined, the addition of solar boards 20 can be considered for causing the solar circuit 30 to generate sufficient voltage. Further, when the voltages of the first node V1 and the second node V2 are enough, the microcomputer unit 50 then generates an active command P1 to the object-sensing circuit 70 for the user to influence. The object-sensing circuit 70 promptly generates a sensing message P2 responding to the approach of the human body and sends the message back to the microcomputer unit 50. When the microcomputer unit 50 receives the sensing message P2, the microcomputer unit 50 accordingly decides whether or not to drive the electromagnetic valve driving circuit 80 and further control the electromagnetic valve 14 to execute an on-off action. It is noted that the microcomputer unit 50 can make deciding instructions relative to the voltage of the voltage determining unit 60. In the preferred embodiment, the microcomputer unit 50 has five modes. The first mode: when the voltage of the first node V1 exceeds 5.5 VL, the outer light source is judged to be lasted on for allowing the solar circuit 30 to keep converting light into electricity, and the microcomputer unit 50 thence delivers the instruction command for leading to the object-sensing circuit 70 executing to sense the object without interruption. The second mode: when the voltage of the first node V1 is lower than 5.5 VL, the outer light source is judged to be off and the solar circuit 30 stops operating, and the microcomputer unit 50 then sends the command for causing the object-sensing circuit 70 stop sensing the human body so as to reduce the power consumption. The third mode: when the voltage of the second node V2 exceeds 7 VH, the capacitor 40 is judged full and the microcomputer unit 50 begins to send the command to cause the electromagnetic valve 14 to normally execute an on-off operation. The fourth mode: when the voltage of the second node V2 is between 5.5 VL and 7 VH, the capacitor 40 is judged to be able to temporarily supply electricity but on the verge of insufficient electricity, and the microcomputer unit 50 then sends the instruction command to allow the electromagnetic valve 14 to proceed turning off the water but forbid the valve to turn on the water. Such command prevents the situation that the capacitor 40 is not full enough to provide the electromagnetic valve 14 with sufficient electricity to proceed the off operation after the electromagnetic valve 14 is on. The fifth mode: when the second node V2 is lower than 5.5 VL, the capacitor 40 is judged insufficient and unable to supply the electromagnetic valve 14 with enough electricity. In this manner, the operation of the electromagnetic valve 14 becomes lagged or inactive. To prevent the problem that the electromagnetic valve 14 cannot execute the off operation as a result of insufficient electricity after the electromagnetic valve 14 is on, the microcomputer unit 50 promptly sends the instruction command to cause the electromagnetic valve 14 to immediately turn the water off once for a fail-safe setting. Accordingly, the solar auto-sensing outlet valve mainly applies the microcomputer unit to determine the voltage value, which controls the whole circuit working and further automatically keeps the operation of the solar auto-sensing outlet valve under control, so as to promote the economic effect of water saving and the using convenience.

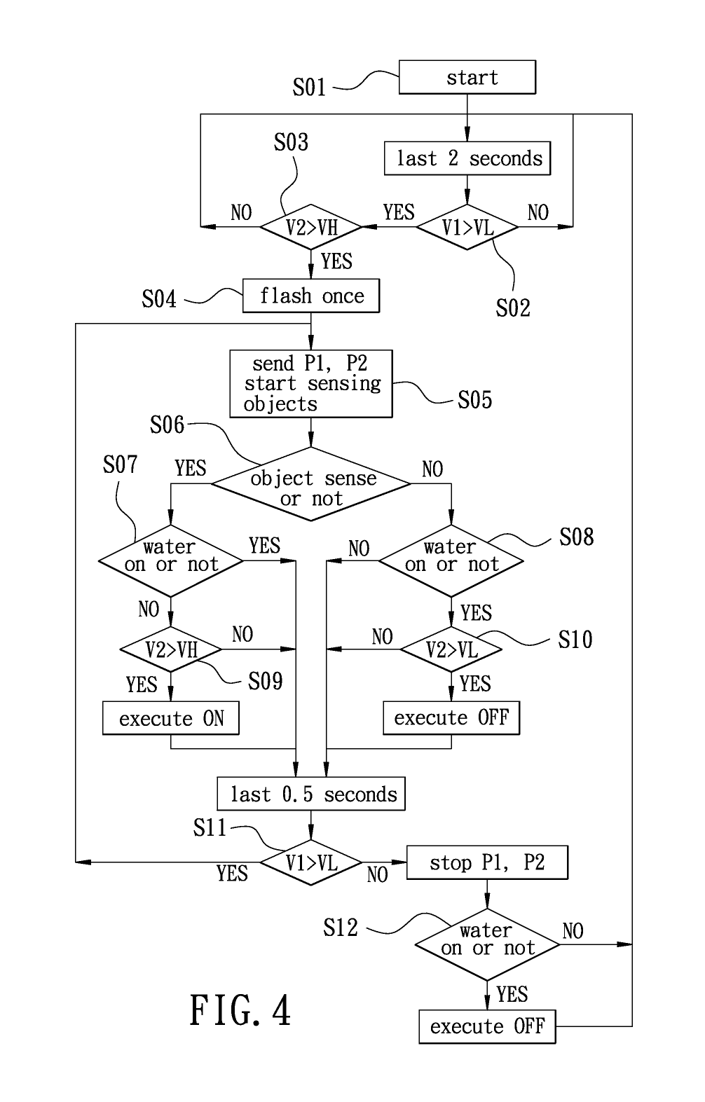

Refer to FIG. 4 showing the operating steps of the present solar auto-sensing outlet valve, which comprises steps of:

(S01) Keeping on standby and postponing;
(S02) Judging whether the voltage of the first node V1 is larger than 5.5 VL; if yes, go to step (S03), if not, restart step (S02).
(S03) Judging whether the voltage of the second node V2 is larger than 7 VH; if yes, go to step (S04), if not, restart step (S02).
(S04) Flashing the full-charge displaying unit 90 once and turning to step (S05).
(S05) Sensing objects via the object-sensing circuit 70.
(S06) Checking if the object-sensing circuit 70 detects any approach of the objects; if yes, go to step (S07), if not, go to step (S08).
(S07) Checking whether or not the electromagnetic valve 14 is on; if yes, go to step (S11), if not, go to step (S09).
(S08) Checking whether or not the electromagnetic valve 14 is on; if yes, go to step (S10), if not, go to step (S11).
(S09) Determining if the voltage of the second node V2 is larger than 7 VH; if yes, the electromagnetic valve 14 executes turning on the water, if not, go to step (S11).
(S10) Determining if the voltage of the second node V2 is larger than 5.5 VL; if yes, the electromagnetic valve 14 executes turning off the water, if not, go to step (S11).
(S11) Determining if the voltage of the first node V1 is larger than 5.5 VL; if yes, go to step (S05), if not, the object-sensing circuit 70 stops sensing and turns to step (S12).
(S12) Checking whether or not the electromagnetic valve 14 is on; if yes, the electromagnetic valve 14 proceeds turning off the water and turns to step (S02), if not, go to step (S02).

While we have shown and described the embodiment in accordance with the present invention, it should be clear to those skilled in the art that further embodiments may be made without departing from the scope of the present invention.

I claim:

1. A solar auto-sensing outlet valve without a use of batteries comprising:
an outlet valve body including a sensor and an electromagnetic valve; wherein, said sensor serves to detect whether users are going nearby and send a corresponding message to said electromagnetic valve for triggering an action thereof, so that said outlet valve body is able to automatically output and stop outputting water;
at least one solar board separately disposed from said outlet valve body and disposed in the vicinity of a light source, said solar board being electrically connected to said sensor and said electromagnetic valve of said outlet valve body via a guiding line, and said solar board being able to combine with a plurality of other solar boards for satisfying demands; and
a full-charge displaying unit disposed between said solar board and said outlet valve body and respectively in an electrical connection therewith, serving to recognize whether a voltage of said solar board is full enough to drive said sensor and said electromagnetic valve of said outlet valve body so as to maintain a normal operation of said solar auto-sensing outlet valve.

2. The solar auto-sensing outlet valve as claimed in claim 1, wherein said full-charge displaying unit is an LED light.

3. The solar auto-sensing outlet valve as claimed in claim 1, wherein said outlet valve body comprises a water inlet and a water outlet disposed at two respective ends thereof, and said sensor and said electromagnetic valve are disposed inside said outlet valve body.

4. The solar auto-sensing outlet valve as claimed in claim 1, wherein an electric plug and an electric socket are respectively and relatively disposed at two sides of said solar board, so that any two adjacent solar boards are plugged together via cooperating said electric plug with said electric socket.

5. A circuit structure adapted to a solar auto-sensing outlet valve without a use of batteries comprising:
a solar circuit including at least one solar board, wherein said solar board is able to combine with a plurality of other solar boards for satisfying demands;
a microcomputer unit electrically connected with said solar circuit and comprising a basic circuit and an electronic element for controlling a normal operation of said solar auto-sensing outlet valve;
a voltage determining unit arranged between said solar circuit and said microcomputer unit and respectively in an electrical connection therewith;
an object-sensing circuit electrically connected with said microcomputer unit to detect and create a message responding to an approach of an object and send said message to said microcomputer unit;
an electromagnetic valve driving circuit electrically connected with said microcomputer unit to receive an instruction command from said microcomputer unit so as to control said electromagnetic valve to execute an on-off action; and
a full-charge displaying unit being an LED light and electrically connected with said microcomputer unit, so that said full-charge displaying unit flashes once when said microcomputer unit detects that said voltage determining unit reaches a predetermined voltage threshold, said voltage determining unit is able to detect whether a voltage of said solar board is full enough to drive said object-sensing circuit and said electromagnetic valve driving circuit for said solar auto-sensing outlet valve to maintain a normal operation.

6. The circuit structure as claimed in claim 5, wherein, said circuit structure further comprises a capacitor electrically connected with said solar circuit for storing electricity created by said solar circuit.

7. The circuit structure as claimed in claim 6, wherein, said voltage determining unit comprises a first node and a second node for respectively detecting voltage values of said solar circuit and said capacitor.

8. The circuit structure as claimed in claim 5, wherein, said circuit structure further comprises a stabilizing circuit disposed between said microcomputer unit and said voltage determining unit, so that said stabilizing circuit is able to firm a voltage converted by said solar circuit.
